(19) United States
(12) Patent Application Publication
(10) Pub. No.: US 2006/0205872 A1
(43) Pub. Date: Sep. 14, 2006

(54) Reinforced Poly(Arylene Ether)/Polyamide Composition and Articles Thereof

(75) Inventor: Mark D. Elkovitch, Selkirk, NY (US)

Correspondence Address: CANTOR COLBURN LLP - NORYL, 55 GRIFFIN ROAD SOUTH, BLOOMFIELD, CT, 06002, US

(73) Assignee: GENERAL ELECTRIC COMPANY, Schenectady, NY (US)

(21) Appl. No.: 11/421,806

(22) Filed: Jun. 2, 2006

Related U.S. Application Data
(63) Continuation-in-part of application No. 10/903,362, filed on Jul. 30, 2004.
(63) Continuation-in-part of application No. 10/910,666, filed on Aug. 3, 2004.
(60) Provisional application No. 60/495,357, filed on Aug. 16, 2003.
(60) Provisional application No. 60/495,357, filed on Aug. 16, 2003.

(51) Int. Cl. C08L 77/00; C08F 290/04

(52) U.S. Cl. 525/66; 524/504

(57) ABSTRACT

A composition comprises 5 to 20 weight percent fibrous filler, based on the total weight of the composition, and a compatibilized blend of a poly(arylene ether) and an aliphatic-aromatic polyamide. The aliphatic-aromatic polyamide comprises units derived from dicarboxylic acid and units derived from diamine. The units derived from dicarboxylic acid comprise 60 to 100 mol % of units derived from terephthalic acid and the units derived from diamine comprise 60 to 100 mol % of units derived from 1,9-nonanediamine, 2-methyl-1,8-octanediamine or a combination of 1,9-nonanediamine and 2-methyl-1,8-octanediamine. The polyamide has an amine end group content greater than 45 micromoles per gram of polyamide prior to melt blending with the poly(arylene ether).

### CROSS REFERENCE TO RELATED APPLICATIONS

This application is a continuation-in-part of U.S. application Ser. No. 10/903,362, filed on Jul. 30, 2004 and U.S. application Ser. No. 10/910,666 filed on Aug. 3, 2004, both of which claim priority to U.S. Provisional Application No. 60/495,357 filed on Aug. 16, 2003, all of which are incorporated by reference herein.

### BACKGROUND OF INVENTION

The disclosure relates to poly(arylene ether)/polyamide compositions.

Poly(arylene ether)/aliphatic polyamide compositions are widely used and the characteristics of the compositions are a result of, at least in part, the characteristics of the poly(arylene ether) and the polyamide. Despite their wide use compositions employing aliphatic polyamides can suffer from drawbacks such as high moisture absorption. Attempts have been made to improve the physical property profile by altering the polyamide structure to include aromatic elements. Compositions employing these aliphatic-aromatic polyamides have improved some physical properties but have diminished other desirable properties. For instance, many aliphatic-aromatic polyamides have melt temperatures above the degradation temperature of many polymers. Thus these aliphatic-aromatic polyamides cannot be blended with many polymers without causing at least partial degradation of the polymer. Some aliphatic-aromatic polyamides have a melt temperature less than the degradation temperature of many polymers but these polyamides usually have inadequate dimensional stability for most applications and blends employing them typically demonstrate poor dimensional stability as well.

Reinforcing agents, such as fibrous non-conductive fillers, have been included in poly(arylene ether)/aliphatic polyamide blends to improve physical characteristics such as flexural strength, tensile strength and heat distortion temperature but increases in the foregoing physical properties are frequently accompanied by losses in tensile elongation, impact strength and flow. In addition, it is more difficult to retain tensile modulus in reinforced poly(arylene ether)/polyamide compositions when subjected to humidity than in non-reinforced poly(arylene ether)/polyamide compositions.

Accordingly there is a need for a reinforced poly(arylene ether)/polyamide composition having a desirable combination of a high heat distortion temperature, processability, and retention of tensile properties, particularly tensile modulus, after being subjected to humidity.

### BRIEF DESCRIPTION OF THE INVENTION

The above mentioned need is addressed by a composition comprising:

5 to 20 weight percent fibrous filler, based on the total weight of the composition; and

a compatibilized blend of a poly(arylene ether) and an aliphatic-aromatic polyamide. The aliphatic-aromatic polyamide comprises:

units derived from dicarboxylic acid wherein 60 to 100 mol % of the units derived from dicarboxylic acid are derived from terephthalic acid and

units derived from diamine wherein 60 to 100 mol % of the units derived from diamine are derived from 1,9-nonanediamine, 2-methyl-1,8-octanediamine units, or a combination of 1,9-nonanediamine and 2-methyl-1,8-octanediamine. The aliphatic-aromatic polyamide has an amine end group content greater than 45 micromoles per gram of polyamide prior to forming the compatibilized blend. The composition has a tensile modulus, after being exposed to 100% humidity and 38° C. for 7 days, that is greater than or equal to 95% of the tensile modulus prior to being exposed to 100% humidity and 38° C. for 7 days.

Also disclosed herein are articles comprising the composition of the previous paragraph.

### BRIEF DESCRIPTION OF THE FIGURES

FIGS. 1 and 2 are graphical representations of data presented in the Examples.

### DETAILED DESCRIPTION

The composition disclosed herein comprises fibrous filler, an optional impact modifier, and a compatibilized blend of poly(arylene ether) and an aliphatic-aromatic polyamide. The polyamide comprises units derived from dicarboxylic acid and units from diamine. At least 60 mol % of the units derived from dicarboxylic acid are derived from terephthalic acid and at least 60 mol % of the units derived from diamine are derived from 1,9-nonanediamine, 2-methyl-1,8-octanediamine or a combination of 1,9-nonanediamine and 2-methyl-1,8-octanediamine. This combination of aromatic units and nine carbon aliphatic units results in an aliphatic-aromatic polyamide which when employed in a compatibilized poly(arylene ether)/polyamide blend, results in a composition having low water absorption when compared to the same blend composition substituting an aliphatic polyamide for the aliphatic-aromatic polyamide.

Reinforced compatibilized poly(arylene ether)/aliphatic polyamide blends show a marked decrease in tensile modulus after water absorption. Although reinforced compatibilized poly(arylene ether)/aliphatic-aromatic polyamide compositions absorb less water than comparable reinforced compatibilized poly(arylene ether)/aliphatic polyamide blends, the reinforced compatibilized poly(arylene ether)/aliphatic-aromatic polyamide compositions would be expected to have an analogous loss in tensile modulus upon moisture absorption. Unexpectedly, compatibilized poly(arylene ether)/aliphatic-aromatic polyamide compositions comprising 5 to 20 weight percent fibrous filler, based on the total weight of the composition, have a tensile modulus after 14 days exposure to 100% humidity and 38° C., of greater than or equal to 95% of the tensile modulus prior to exposure to heat and humidity. Stated another way, the tensile modulus of a composition comprising 5 to 20 weight percent fibrous filler in a compatibilized poly(arylene ether)/aliphatic-aromatic polyamide blend and having a moisture content of 0.6 to 1.5 weight percent (wt %), has a tensile modulus that is greater than or equal to 95% of the tensile modulus of a comparable composition having less than or equal to 0.1 wt % moisture. This unexpected result is in marked contrast to the behavior of reinforced compatibilized poly(arylene ether)/aliphatic polyamide blends such as reinforced compatibilized poly(arylene ether)/aliphatic polyamide blends having 5 to 20 weight percent fibrous filler. Generally, compatibilized poly(arylene ether)/aliphatic polyamide blends comprising 5 to 20 weight percent fibrous filler and having a moisture content greater than or equal to 0.6 wt % moisture have a tensile modulus that is less than or equal to 87% of the tensile modulus of a comparable composition having less than or equal to 0.1 wt % moisture.

To determine moisture content the composition, in the form of pellets, is dried at 170° C. for three to four hours and subsequently injection molded into 4 millimeter (mm)×4 mm×80 mm bars. Immediately after molding the bars are sealed in foil bags. Prior to sealing the bags excess air is pushed out of the bags to minimize the atmosphere in the bags. The bars are left in the foil bags for twenty-four hours at 23° C. for temperature equilibration. The bars are then removed and weighed. After weighing the bars are exposed to 100% humidity and 38° C. for a specified period. At the end of a specified period, three bars are removed, wiped dry of surface moisture, and weighed. Moisture absorption is determined by the average increase in weight of three samples.

To correlate tensile modulus changes with moisture content the composition is dried, molded into tensile bars and cooled in sealed bags in the same manner as the samples for moisture absorption. The tensile bars are subsequently exposed to 100% humidity and 38° C. as described above for moisture absorption and tested for tensile strength according to ASTM D 638-03 using Type I specimens having a thickness of 3.175 millimeters. Testing is conducted at 23° C. and a speed of 5 millimeters/minute. Values are an average of 5 specimens.

In one embodiment, the composition has a heat distortion temperature (HDT) 200 to 260° C. when measured according to ASTM D 648-01 at 1.8 Mpa using samples having a thickness of 6.4 millimeters. In some embodiments the composition may have an HDT greater than or equal to 210° C., or, more specifically, greater than or equal to 220° C.

In one embodiment, the composition maintains greater than or equal to 98.5%, or, more specifically, greater than or equal to 98.7%, or, even more specifically greater than or equal to 99.0% of its original weight after five milligrams is heated at 177° C. for twenty four hours in a closed environment. Prior to testing the five milligram sample is dried for 24 hours at 120° C. at a reduced pressure. Maintaining greater than or equal to 98.5% of the original weight indicates little or no outgassing, making the composition suitable for use in applications where outgassing is a concern such as various electronic and lighting applications. For example, the bases of automotive headlights when made of polymeric compositions and enclosed in the lighting fixture benefit from little or no outgassing because outgassing can cause a film or fog to form on the inside of lighting fixture lens which can reduce the effectiveness of the automotive headlight.

In some embodiments, the composition has a water absorption value less than or equal to 0.3 wt % after 24 hours, or more specifically, less than or equal to 0.25 wt % after 24 hours, or, even more specifically less than or equal to 0.2 wt % after 24 hours, when exposed to 100% humidity ant 38° C.

As used herein, a “poly(arylene ether)” comprises a plurality of structural units of the formula (I): 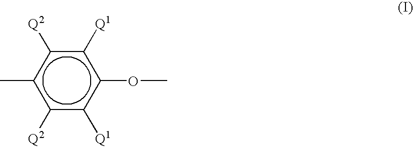
wherein for each structural unit, each Q¹ and each Q² is independently hydrogen, halogen, primary or secondary lower alkyl (e.g., an alkyl containing 1 to 7 carbon atoms), haloalkyl, aminoalkyl, alkenylalkyl, alkynylalkyl, aryl (e.g., phenyl), hydrocarbonoxy, and halohydrocarbonoxy wherein at least two carbon atoms separate the halogen and oxygen atoms. In some embodiments, each Q¹ is independently alkyl or phenyl, for example, C₁₋₄ alkyl, and each Q² is independently hydrogen or methyl. The poly(arylene ether) may comprise molecules having aminoalkyl-containing end group(s), typically located in an ortho position to the hydroxy group. Also frequently present are end groups resulting from backward dimer incorporation during the manufacture of the poly(arylene ether), e.g., tetramethyl diphenylquinone (TMDQ), when 2,6-xylenol is used as a monomer.

The poly(arylene ether) may be in the form of a homopolymer; a copolymer; a graft copolymer; an ionomer; a block copolymer, for example comprising arylene ether units and blocks derived from alkenyl aromatic compounds; as well as combinations comprising at least one of the foregoing. Poly(arylene ether) includes polyphenylene ether comprising 2,6-dimethyl- 1,4-phenylene ether units optionally in combination with 2,3,6-trimethyl-1,4-phenylene ether units.

The poly(arylene ether) may be prepared by the oxidative coupling of monohydroxyaromatic compound(s) such as 2,6-xylenol, 2,3,6-trimethylphenol or a combination of 2,6-xylenol and 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide, or combination of two or more of the foregoing.

The poly(arylene ether) can have a number average molecular weight of 3,000 to 40,000 grams per mole (g/mol), a weight average molecular weight of 5,000 to 80,000 g/mol, or a number average molecular weight of 3,000 to 40,000 grams per mole (g/mol) and a weight average molecular weight of 5,000 to 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) can have an initial intrinsic viscosity of 0.10 to 0.60 deciliters per gram (dl/g), or, more specifically, 0.29 to 0.48 dl/g, as measured in chloroform at 25° C. Initial intrinsic viscosity is defined as the intrinsic viscosity of the poly(arylene ether) prior to melt mixing with the other components of the composition and final intrinsic viscosity is defined as the intrinsic viscosity of the poly(arylene ether) after melt mixing with the other components of the composition. As understood by one of ordinary skill in the art the intrinsic viscosity of the poly(arylene ether) may be up to 30% higher after melt mixing. The percentage of increase can be calculated by (final intrinsic viscosity—initial intrinsic viscosity)/initial intrinsic viscosity. Determining an exact ratio, when two initial intrinsic viscosities are used, will depend somewhat on the exact intrinsic viscosities of the poly(arylene ether) used and the ultimate physical properties that are desired.

In one embodiment, the poly(arylene ether) has a glass transition temperature (Tg) as determined by differential scanning calorimetry in a nitrogen atmosphere (DSC at 20° C./minute ramp), of 160° C. to 280° C. Within this range the Tg may be greater than or equal to 180° C., or, more specifically, greater than or equal to 200° C. Also within this range the Tg may be less than or equal to 270° C., or, more specifically, less than or equal to 260° C.

The composition may contain poly(arylene ether) in an amount of 10 weight percent to 50 weight percent based on the combined weight of poly(arylene ether), polyamide and optional impact modifier. Within this range the amount of poly(arylene ether) may be greater than or equal to 15, or, more specifically, greater than or equal to 20 weight percent. Also within this range the amount of poly(arylene ether) may be less than or equal to 48, or, more specifically, less than or equal to 45 weight percent.

The aliphatic-aromatic polyamide comprises units derived from one or more dicarboxylic acids and units derived from one or more diamines. 60 to 100 mol % of the units derived from dicarboxylic acid are derived from terephthalic acid, based on the total moles of units derived from dicarboxylic acid. Within this range the amount of units derived from terephthalic acid may be greater than or equal to 75 mol %, or, more specifically, greater than or equal to 90 mol %.

Examples of other dicarboxylic acids that may be used in addition to the terephthalic acid include aliphatic dicarboxylic acids such as malnic acid, dimethylmalonic acid, succinic acid, glutaric acid, adipic acid, 2-methyladipic acid, trimethyladipic acid, pimelic acid, 2,2-dimethylglutaric acid, 3,3-diethylsuccinic acid, azelaic acid, sebacic acid and suberic acid; alicyclic dicarboxylic acids such as 1,3-cyclopentanedicarboxylic acid and 1,4-cyclohexanedicarboxylic acid; and aromatic dicarboxylic acids such as isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid and 4,4′-biphenyldicarboxylic acid. These can be used singly, in combination or in combinations of two or more types. In one embodiment the content of units derived from dicarboxylic acid other than terephthalic acid is less than or equal to 25 mol %, or, more specifically, less than or equal to 10 mol %, based on the total quantity of units derived from dicarboxylic acid. Units derived from polyfunctionalized carboxylic acids such as trimellitic acid, trimesic acid and pyromellitic acid may also be included to the extent that melt molding of the composition is still possible.

The aliphatic-aromatic polyamide comprises units derived from one or more diamines. 60 to 100 mol % of the units derived from diamines are derived from 1,9-nonanediamine, 2-methyl-1,8-octanediamine, or a combination of 1,9-nonanediamine and 2-methyl-1,8-octanediamine, based on the total moles of units derived from diamines. Within this range the amount of units derived from 1,9-nonanediamine, 2-methyl-1,8-octanediamine, or a combination thereof may be greater than or equal to 75 mol %, or, more specifically, greater than or equal to 90 mol %.

The molar ratio of units derived from 1,9-nonanediamine to units derived from 2-methyl-1,8-octanediamine may be 100:0 to 20:80, or, more specifically, 100:0 to 50:50, or, even more specifically, 100:0 to 50:40. This can be referred to as the N/I ratio.

Examples of other diamines that may be used in addition to the 1,9-nonanediamine, 2-methyl-1,8-octanediamine or combination thereof include linear aliphatic diamines such as 1,6-hexanediamine, 1,7-heptanediamine, 1,8-octanediamine, 1,10-decanediamine, 1,11-undecanediamine and 1,12-dodecanediamine; branched aliphatic diamines such as 2-methyl-1,5-pentanediamine, 3-methyl-1,5-pentanediamine, 2,2,4-trimethyl-1,6-hexanediamine, 2,4,4-trimethyl-1,6-hexanediamine and 5-methyl-1,9-nonanediamine; alicyclic diamines such as cyclohexanediamine, methylcyclohexanediamine, isophoronediamine, bis(4-aminocyclohexyl)methane, norbornanedimethylamine and tricyclodecanedimethylamine; and aromatic diamines such as p-phenylenediamine, m-phenylenediamine, m-xylylenediamine, p-xylylenediamine, 4,4′-diaminodiphenylsulfone and 4,4′-diaminodiphenyl ether. These can be used singly, in combination, or in combinations of two or more types. In one embodiment, units derived from 1,6-hexanediamine, 1,7-heptanediamine, 1,8-octanediamine, 1,10-decanediamine, 1,12-dodecanediamine, or combinations thereof are combined with the 1,9-nonanediamine, 2-methyl-1,8-octanediamine, or a combination of 1,9-nonanediamine and 2-methyl-1,8-octanediamine.

The aliphatic-aromatic polyamide can be manufactured by any known method for manufacturing crystalline polyamides. For example, it can be manufactured by solution polymerization or interfacial polymerization in which an acid chloride and a diamine are used as raw materials, or by melt polymerization, solid-phase polymerization, or melt extrusion polymerization in which a dicarboxylic acid and a diamine are used as raw materials.

The intrinsic viscosity of the aliphatic-aromatic polyamide, measured in concentrated sulfuric acid at 30° C., may be 0.4 to 3.0 dl/g, or, more specifically, 0.5 to 2.0 dl/g, or, even more specifically, 0.6 to 1.8 dl/g.

The melt viscosity of the aliphatic-aromatic polyamide may be 300 to 3500 poise at a shear rate of 1000 s⁻¹ and a temperature of 330° C., as measured by capillary viscometry. Within this range, the melt viscosity may be greater than or equal to 325, or, more specifically, greater than or equal to 350 poise. Also within this range, the melt viscosity may be less than or equal to 3300, or, more specifically, less than or equal to 3100 poise.

The aliphatic-aromatic polyamide, prior to melt mixing with the poly(arylene ether), has an amine end group content greater than or equal to 45 micromoles per gram of polyamide, or more specifically, greater than or equal to 50 micromoles, or, even more specifically, greater than or equal to 55 micromoles per gram of polyamide. Amine end group content may be determined by dissolving the polyamnide in a suitable solvent, optionally with heat. The polyamide solution is titrated with 0.01 Normal hydrochloric acid (HCl) solution using a suitable indication method. The amount of amine end groups is calculated based the volume of HCl solution added to the sample, the volume of HCl used for the blank, the molarity of the HCl solution and the weight of the polyamide sample.

The compatibilized blend may further comprise an additional polyamide such as nylon 6, 6/6, 6/69, 6/10, 6/12, 11, 12, 4/6, 6/3, 7, 8, 6T, modified 6T, polyphthalamides (PPA), and combinations of two or more of the foregoing.

The amount of aliphatic-aromatic polyamide in the composition is such that the aliphatic-aromatic polyamide is a continuous phase. The composition may contain aliphatic-aromatic polyamide in an amount of 40 weight percent to 80 weight percent based on the combined weight of poly(arylene ether), polyamide and optional impact modifier. Within this range the amount of aliphatic-aromatic polyamide may be greater than or equal to 42, or, more specifically, greater than or equal to 45 weight percent. Also within this range the amount of aliphatic-aromatic polyamide may be less than or equal to 70, or, more specifically, less than or equal to 60 weight percent. Within these ranges, the amount of aliphatic-aromatic polyamide can at least in part be determined by the desired properties of the composition without undue experimentation by one of skill in the art.

The compatibilized poly(arylene ether)/aliphatic-aromatic polyamide blend is formed using a compatibilizing agent. When used herein, the expression “compatibilizing agent” refers to polyfunctional compounds which interact with the poly(arylene ether), the polyamide resin, or both. This interaction may be chemical (e.g., grafting), physical (e.g., affecting the surface characteristics of the dispersed phases), or chemical and physical. In either instance the resulting compatibilized poly(arylene ether)/polyamide composition appears to exhibit improved compatibility, particularly as evidenced by enhanced ductility, mold knit line strength, elongation, or a combination thereof. As used herein, the expression “compatibilized poly(arylene ether)/polyamide blend” refers to those compositions which have been physically compatibilized, chemically compatibilized, or both with a compatibilizing agent.

As understood by one of ordinary skill in the art, poly(arylene ether) and polyamide, when combined, form an immiscible blend. Immiscible blends have either a continuous phase and a dispersed phase or two co-continuous phases. When a continuous phase and a dispersed phase are present the size of the particles of the dispersed phase can be determined using electron microscopy. In a compatibilized poly(arylene ether)/polyamide blend the average diameter of the dispersed phase particles (poly(arylene ether)) is decreased compared to non-compatibilized poly(arylene ether)/polyamide blends. For example, compatibilized poly(arylene ether)/polyamide blends have an average poly(arylene ether) particle diameter less than or equal to 10 micrometers. In some embodiments the average particle diameter is greater than or equal to 0.05 micrometers. The average particle diameter in a pelletized blend may be smaller than in a molded article but in either case the average particle diameter is less than or equal to 10 micrometers. Determination of average particle diameter is known in the art and is taught, for example, in U.S. Pat. Nos. 4,772,664 and 4,863,996.

The compatibilizing agent comprises a monomeric polyfunctional compound that is one of two types. The first type has in the molecule both (a) a carbon-carbon double bond and b) at least one carboxylic acid, anhydride, epoxy, imide, amide, ester group or functional equivalent thereof. Examples of such polyfunctional compounds include maleic acid; maleic anhydride; fumaric acid; maleic hydrazide; dichloro maleic anhydride; and unsaturated dicarboxylic acids (e.g. acrylic acid, butenoic acid, methacrylic acid, t-ethylacrylic acid, pentenoic acid). In one embodiment, the compatibilizing agent comprises maleic anhydride, fumaric acid, or a combination thereof.

The second type of polyfunctional compatibilizing agent compounds are characterized as having both (a) a group represented by the formula (OR) wherein R is hydrogen or an alkyl, aryl, acyl or carbonyl dioxy group and (b) at least two groups each of which may be the same or different selected from carboxylic acid, acid halide, anhydride, acid halide anhydride, ester, orthoester, amide, imido, amino, and salts thereof. Typical of this type of compatibilizing agents are the aliphatic polycarboxylic acids, acid esters and acid amides represented by the formula:
(R^{I}O)ₘR^{V}(COOR^{II})ₙ(CONR^{III}R^{IV})ₛ
wherein R^{V} is a linear or branched chain saturated aliphatic hydrocarbon having 2 to 20, or, more specifically, 2 to 10 carbon atoms; each R^{I} is independently hydrogen or an alkyl, aryl, acyl or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III}, and R^{IV} are independently hydrogen or an alkyl or aryl group having 1 to 10, or, more specifically 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (OR^{I}) is alpha or beta to a carbonyl group and at least two carbonyl groups are separated by 2 to 6 carbon atoms. Obviously, R^{I}, R^{II}, R^{III} and R^{IV} cannot be aryl when the respective substituent has less than 6 carbon atoms.

Polyfunctional compatibilizing agents of the second type also include, for example, citric acid, malic acid, agaricic acid; including the various commercial forms thereof, such as for example, the anhydrous and hydrated acids; and combinations comprising one or more of the foregoing. In one embodiment, the compatibilizing agent comprises citric acid. Illustrative of esters useful herein include, for example, acetyl citrate and mono- and/or distearyl citrates and the like. Suitable amides useful herein include, for example, N,N′-diethyl citric acid amide; N-phenyl citric acid amide; N-dodecyl citric acid amide; N,N′-didodecyl citric acid amide and N-dodecyl malic acid. Derivates include the salts thereof, including the salts with amines and the alkali and alkaline metal salts. Exemplary suitable salts include calcium malate, calcium citrate, potassium malate, and potassium citrate.

The thermoplastic composition is produced by melt blending the components. The foregoing compatibilizing agents may be added directly to the melt blend or pre-reacted with either or both the poly(arylene ether) and polyamide. In one embodiment, at least a portion of the compatibilizing agent is pre-reacted, either in the melt or in a solution of a suitable solvent, with all or a part of the poly(arylene ether). It is believed that such pre-reacting may cause the compatibilizing agent to react with the polymer and, consequently, functionalize the poly(arylene ether). For example, at least a portion of the poly(arylene ether) may be pre-reacted with maleic anhydride, fumaric acid, citric acid, or a combination thereof to form an anhydride, acid, or anhydride and acid functionalized poly(arylene ether) which has improved compatibility with the polyamide compared to a non-functionalized poly(arylene ether).

The amount of the compatibilizing agent used will be dependent upon the specific compatibilizing agent chosen and the specific polymeric system to which it is added as well as the desired properties of the resultant composition.

In one embodiment, the compatibilizing agent is employed in an amount of 0.05 to 2.0 weight percent, based on the combined weight of poly(arylene ether), aliphatic-aromatic polyamide, and optional impact modifier. Within this range the amount of compatibilizing agent may be greater than or equal to 0.1, or, more specifically, greater than or equal to 0.2 weight percent. Also within this range the amount of compatibilizing agent may be less than or equal to 1.75, or, more specifically, less than or equal to 1.5 weight percent.

The fibrous filler may be any conventional filler having an aspect ratio (length/width) greater than 1. In some embodiments the aspect ratio is 1 to 1000. Such fillers may exist in the form of whiskers, needles, rods, tubes, strands, elongated platelets, lamellar platelets, ellipsoids, micro fibers, nanofibers and nanotubes, elongated fullerenes, and the like. Where such fillers exist in aggregate form, the aggregate may have an aspect ratio greater than 1. Non-limiting examples of fibrous fillers include short inorganic fibers, processed mineral fibers such as those derived from blends comprising at least one of aluminum silicates, aluminum oxides, magnesium oxides, and calcium sulfate hemihydrate; boron fibers; ceramic fibers such as silicon carbide; and fibers from mixed oxides of aluminum, boron and silicon. Also included among fibrous fillers are single crystal fibers or “whiskers” including silicon carbide, alumina, boron carbide, iron, nickel, copper. Fibrous fillers such as glass fibers, basalt fibers, including textile glass fibers and quartz may also be included.

An addition, organic reinforcing fibrous fillers and synthetic reinforcing fibers may be used. This includes organic polymers capable of forming fibers such as polyethylene terephthalate, polybutylene terephthalate and other polyesters, polyarylates, polyethylene, polyvinylalcohol, polytetrafluoroethylene, acrylic resins, high tenacity fibers with high thermal stability including aromatic polyamides, polyaramid fibers such as KEVLAR (product of DuPont), polybenzimidazole, polyimide fibers such as polyimide 2080 and PBZ fiber (both products of Dow Chemical Company), polyphenylene sulfide, polyether ether ketone, polyimide, polybenzoxazole, aromatic polyimides or polyetherimides, poly(arylene ether) and the like. Combinations comprising two or more of any of the foregoing fibers may also be used.

The fibrous filler is not electrically conductive. Thus compositions containing the fibrous filler, in the absence of electrically conductive filler, have substantially the same or greater resistivity than comparable compositions free of the fibrous filler and electrically conductive filler. Specifically, the term fibrous filler, as used herein, does not include carbon fibers, carbon fibrils, or carbon nanotubes.

Such fibrous filler may be provided in the form of monofilament or multifilament fibers and can be used either alone or in combination with other types of fiber, through, for example, co-weaving or core/sheath, side-by-side, orange-type or matrix and fibril constructions, or by other methods known to one skilled in the art of fiber manufacture. Typical cowoven structures include glass fiber-carbon fiber, carbon fiber-aromatic polyimide (aramid) fiber, and aromatic polyimide fiberglass fiber. Fibrous non-conductive fillers may be supplied in the form of, for example, rovings, woven fibrous reinforcements, such as 0-90 degree fabrics, non-woven fibrous reinforcements such as continuous strand mat, chopped strand mat, tissues, papers and felts and 3-dimensionally woven reinforcements, preforms and braids.

In a one embodiment, glass fibers can be used as the fibrous filler. Useful glass fibers can be formed from any type of fiberizable glass composition known to those skilled in the art, and include those prepared from fiberizable glass compositions commonly known as “E-glass,” “A-glass,” “C-glass,” “D-glass,” “R-glass,” “S-glass,” as well as E-glass derivatives that are fluorine-free, boron-free, or fluorine and boron free. Most reinforcement mats comprise glass fibers formed from E-glass.

Commercially produced glass fibers generally having nominal filament diameters of 4.0 to 35.0 micrometers, and most commonly produced E-glass fibers having nominal filament diameters of 9.0 to 30.0 micrometers. The filaments are made by standard processes, e.g., by steam or air blowing, flame blowing and mechanical pulling. In one embodiment the filaments are made by mechanical pulling. Use of non-round fiber cross section is also possible. The glass fibers may be sized or unsized. Sized glass fibers are conventionally coated on at least a portion of their surfaces with a sizing composition selected for compatibility with the polymeric matrix material. The sizing composition facilitates wet-out and wet-through of the matrix material upon the fiber strands and assists in attaining desired physical properties in the composite.

The glass fibers include glass strands that have been sized. In preparing the glass fibers, a number of filaments can be formed simultaneously, sized with the coating agent and then bundled into what is called a strand. Alternatively the strand itself may be first formed of filaments and then sized. Glass fibers in the form of chopped strands one-fourth inch long or less or, more specifically, less than or equal to one-eighth inch long may be used to make the composition. They may also be longer than one-fourth inch in length if desired.

The fibrous filler is present in an amount of 5 to 20 weight percent, based on the total weight of the composition. Within this range the fibrous filler may be present in an amount greater than or equal to 7 weight percent. Also within this range the fibrous filler may be present in an amount less than or equal to 15 weight percent.

The composition may optionally further comprise an impact modifier. Useful impact modifiers include block copolymers of an alkenyl aromatic compound and a conjugated diene, hydrogenated block copolymers of an alkenyl aromatic compound and a conjugated diene, functionalized elastomeric polyolefins and combinations of two or more of the foregoing.

The block copolymers are copolymers comprising (A) at least one block comprising units derived from an alkenyl aromatic compound and (B) at least one block comprising units derived from a conjugated diene or a copolymer comprising units derived from a conjugated diene compound and units derived from an alkenyl aromatic compound. Hydrogenated block copolymers are those in which the aliphatic unsaturated group content in the block (B) is reduced by hydrogenation. The arrangement of blocks (A) and (B) includes a linear structure and a so-called radial teleblock structure having branched chains.

Exemplary structures include linear structures embracing diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of A and B. In one embodiment the structure is a diblock, triblock, tetrablock or combination thereof, or, more specifically, an A-B diblock, an A-B-A triblock or a combination thereof.

The alkenyl aromatic compound providing the units of block (A) or units of the copolymer of block (B) is represented by formula: 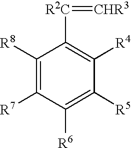
wherein R² and R³ each independently represent a hydrogen atom, a C₁-C₈ alkyl group, a C₂-C₈ alkenyl group, or the like; R⁴ and R⁸ each independently represent a hydrogen atom, a C₁-C₈ alkyl group, a chlorine atom, a bromine atom, or the like; and R⁵-R⁷ each independently represent a hydrogen atom, a C₁-C₈ alkyl group, a C₂-C₈ alkenyl group, or the like, or R⁴ and R⁵ are taken together with the central aromatic ring to form a naphthyl group, or R⁵ and R⁶ are taken together with the central aromatic ring to form a naphthyl group.

Specific examples of the alkenyl aromatic compounds include styrene, para-methylstyrene, alpha-methylstyrene, vinylxylenes, vinyltoluenes, vinylnaphthalenes, divinylbenzenes, bromostyrenes, chlorostyrenes, and the like, and combinations comprising at least one of the foregoing alkenyl aromatic compounds. In one embodiment the alkenyl aromatic compound is selected from styrene, alpha-methylstyrene, para-methylstyrene, vinyltoluenes, and vinylxylenes. In another embodiment the alkenyl aromatic compound is styrene.

Specific examples of the conjugated diene include 1,3-butadiene, 2-methyl-1,3-butadiene, 2,3-dimethyl-1,3-butadiene, 1,3-pentadiene, and the like as well as combinations comprising one or more of the foregoing conjugated dienes.

In addition to the conjugated diene, the hydrogenated block copolymer may contain a small proportion of a lower olefinic hydrocarbon such as, for example, ethylene, propylene, 1-butene, dicyclopentadiene, a non-conjugated diene, or the like.

There is no particular restriction on the content of the repeating unit derived from the alkenyl aromatic compound in the block copolymers. Suitable alkenyl aromatic content may be 10 to 90 weight percent based on the total weight of the block copolymer. Within this range, the alkenyl aromatic content may be greater than or equal to 40 weight percent, or, more specifically, greater than or equal to 50 weight percent, or, even more specifically, greater than or equal to 55 weight percent. Also within this range, the alkenyl aromatic content may be less than or equal to 85 weight percent, or, more specifically, less than or equal to 75 weight percent.

There is no particular limitation on the mode of incorporation of the conjugated diene in the hydrogenated block copolymer backbone. For example, when the conjugated diene is 1,3-butadiene, it may be incorporated with 1% to 99% 1,2-incorporation with the remainder being 1,4-incorporation.

The hydrogenated block copolymer may be hydrogenated to such a degree that fewer than 50%, or, more specifically fewer than 20%, or, even more specifically, fewer than 10%, of the unsaturated bonds in the aliphatic chain moiety derived from the conjugated diene remain unreduced. The aromatic unsaturated bonds derived from the alkenyl aromatic compound may be hydrogenated to a degree of up to 25%.

The hydrogenated block copolymer may have a number average molecular weight of 5,000 to 500,000 atomic mass units (AMU), as determined by gel permeation chromatography (GPC) using polystyrene standards. Within this range, the number average molecular weight may be at least 10,000 AMU, or more specifically greater than or equal to 30,000 AMU, or, even more specifically, greater than or equal to 45,000 AMU. Also within this range, the number average molecular weight may less than or equal to 300,000 AMU, or, more specifically less than or equal to 200,000 AMU, or, even more specifically, less than or equal to up to 150,000 AMU.

The molecular weight distribution of the hydrogenated block copolymer as measured by GPC is not particularly limited. The copolymer may have any ratio of weight average molecular weight to number average molecular weight.

Exemplary hydrogenated block copolymers are the styrene-(ethylene-butylene) diblock and styrene-(ethylene-butylene)-styrene triblock copolymers obtained by hydrogenation of styrene-butadiene and styrene-butadiene-styrene triblock copolymers, respectively as well as combinations thereof.

Suitable hydrogenated block copolymers include those commercially available as, for example, KRATON G1650, G1651, and G1652 available from IL TON Polymers (formerly a division of Shell Chemical Company), and TUFTEC H1041, H1043, H1052, H1062, H1141, and H1272 available from Asahi Chemical.

Exemplary non-hydrogenated block copolymers include polystyrene-polybutadiene, polystyrene-poly(ethylene-propylene), polystyrene-polyisoprene, poly(α-methylstyrene)-polybutadiene, polystyrene-polybutadiene-polystyrene (SBS), polystyrene-poly(ethylene-propylene)-polystyrene, polystyrene-polyisoprene-polystyrene and poly(alpha-methylstyrene)-polybutadiene-poly(alpha-methylstyrene), as well as combinations of two or more of the foregoing.

Suitable non-hydrogenated block copolymers are available commercially from a number of sources, including Phillips Petroleum under the trademark SOLPRENE, KRATON Polymers under the trademark KRATON, Dexco under the trademark VECTOR, and Kuraray under the trademark SEPTON.

Other useful impact modifiers include functionalized elastomeric polyolefins containing at least one functional group selected from the group consisting of carboxylic acid groups, esters, acid anhydrides, epoxy groups, oxazoline groups, carbodiimide groups, isocyanate groups, silanol groups, carboxylates, and combinations of two or more of the foregoing functional groups. The elastomeric polyolefin is a polyolefin miscible with the polyamide and includes linear random copolymers, linear block copolymer and core-shell type copolymers wherein the shell is miscible with polyamide and comprises a functional group reactive with the polyamide. Exemplary polyolefins include polyethylene, ethylene-vinyl acetate copolymer (EVA), ethylene- ethylacrylate copolymer (EEA), ethylene-octene copolymer, ethylene- propylene copolymer, ethylenebutene copolymer, ethylene-hexene copolymer, or ethylene-propylene-diene terpolymers. Monomers comprising the functional group may be graft-polymerized with the polyolefin or co-polymerized with the polyolefin monomers. In one embodiment the structural units of the elastomeric polyolefin are derived from ethylene and at least one C₃₋₈ olefin, such as, propylene, 1-butene, 1-hexene, and 1-octene.

Suitable functionalized elastomeric polyolefins are available commercially from a number of sources, including DuPont under the trademark ELVALOY.

The selection of the type of impact modifier or combination of types of impact modifier, may be based, at least in part, on the melt temperature of the polyamide and the temperature profile of the impact modifier.

The composition may comprise the impact modifier or combination of impact modifiers in an amount of 3 to 30 weight percent, based on the combined weight of poly(arylene ether), polyamide and impact modifier. Within this range the amount of impact modifier or combination of impact modifiers may be greater than or equal to 4, or, more specifically greater than or equal to 5 weight percent. Also within this range the amount of impact modifier or combination of impact modifiers may be less than or equal to 25, or, more specifically less than or equal to 20 weight percent.

The composition may further comprise effective amounts of at least one additive selected from the group consisting of anti-oxidants; flame retardants; drip retardants; dyes; pigments; colorants; stabilizers; small particle mineral such as clay, mica, and talc; electrically conductive filler, such as electrically conductive carbon black, carbon fibrils, carbon fibers, and carbon nanotubes; antistatic agents; plasticizers; lubricants; blowing agents; and mixtures thereof. Electrically conductive filler, as used herein, is distinct and separate from the fibrous filler described above. These additives are known in the art, as are their effective levels and methods of incorporation. Effective amounts of the additives vary widely, but they are usually present in an amount up to 50 wt % or more, based on the weight of the entire composition. Some additives such as hindered phenols, thio compounds and amides derived from various fatty acids are generally present in amounts 2% total combined weight based on the total weight of the composition.

Exemplary flame retardants include halogenated flame retardants; organic phosphates including cyclic phosphates; compounds containing phosphorus-nitrogen bonds, such as phosphonitrilic chloride, phosphorus ester amides; phosphoric acid amides, phosphonic acid amides, phosphinic acid amides, tris(aziridinyl) phosphine oxide; tetrakis(hydroxymethyl) phosphonium chloride; mono-, di-, and polymeric phosphinates, magnesium hydroxide, magnesium carbonate, red phosphorus; melamine polyphosphate; melem phosphate, melam phosphate; melamine pyrophosphate; melamine; melamine cyanurate; zinc compounds such as zinc borate; and combinations comprising at least one of the foregoing. Flame retardants are typically used in amounts sufficient to provide the composition with sufficient flame retardance to pass a proscribed flame retardancy standard such as Underwriter's Laboratory Bulletin 94 entitled “Tests for Flammability of Plastic Materials, UL94”. The relevant flame retardancy standard may be determined by the final application.

In one embodiment the composition consists essentially of 5 to 20 wt % glass fiber, based on the total weight of the composition, and a compatibilized blend of a poly(arylene ether) and an aliphatic-aromatic polyamide. The aliphatic-aromatic polyamide comprises units derived from dicarboxylic acid wherein 60 to 100 mol % of the units derived from dicarboxylic acid are derived from terephthalic acid and units derived from diamine wherein 60 to 100 mol % of the units derived from diamine are derived from 1,9-nonanediamine, 2-methyl-1,8-octanediamine units, or a combination of 1,9-nonanediamine and 2-methyl-1,8-octanediamine. The aliphatic-aromatic polyamide, prior to forming the compatibilized blend, has an amine end group content greater than 45 micromoles per gram of aliphatic-aromatic polyamide. As used herein the phrase “consisting essentially of” allows for the inclusion of additives that do not alter the tensile modulus of the composition after exposure to humidity.

In one embodiment the composition consists of 5 to 20 wt % glass fiber and 0 to 50wt % additives, based on the total weight of the composition, and a compatibilized blend of a poly(arylene ether) and an aliphatic-aromatic polyamide. The aliphatic-aromatic polyamide comprises units derived from dicarboxylic acid wherein 60 to 100 mol % of the units derived from dicarboxylic acid are derived from terephthalic acid and units derived from diamine wherein 60 to 100 mol % of the units derived from diamine are derived from 1,9-nonanediamine, 2-methyl-1,8-octanediamine units, or a combination of 1,9-nonanediamine and 2-methyl-1,8-octanediamine. The aliphatic-aromatic polyamide, prior to forming the compatibilized blend, has an amine end group content greater than 45 micromoles per gram of aliphatic-aromatic polyamide.

The composition can be prepared melt mixing or a combination of dry blending and melt mixing. Melt mixing can be performed in single or twin screw type extruders or similar mixing devices which can apply a shear to the components.

All of the ingredients may be added initially to the processing system. In some cases it is desirable to add the fibrous downstream to limit fiber breakage. In one embodiment, the poly(arylene ether), optionally other ingredients such as an impact modifier, and optionally a portion of the polyamide may be melt mixed with the compatibilizing agent before melt mixing with the other components. This is sometimes known as “precompounding”. In some embodiments the precompounded components may be pelletized and later combined with the remaining components of the composition. When the polyamide is added in two portions, the remaining portion of the polyamide is added after the first ingredients have been melt mixed. When using an extruder, the second portion of polyamide may be fed through a port downstream. While separate extruders may be used in the processing, preparations in a single extruder having multiple feed ports along its length to accommodate the addition of the various components simplifies the process. It is often advantageous to apply a vacuum to the melt through one or more vent ports in the extruder to remove volatile impurities in the composition. In some embodiments comprising an additive such as a filler or reinforcing agent it may be advantageous to introduce the additive to the other components of the composition as part of a masterbatch. For example, it is frequently useful to melt mix fillers with polyamide to form a masterbatch and add the masterbatch to the remaining components, usually downstream of the extruder feedthroat.

The composition is typically pelletized after leaving the extruder and these pellets may be subsequently formed into an article using a low shear or high shear forming processes such as injection molding, compression molding, profile extrusion, film and sheet extrusion, gas-assist injection molding, and extrusion molding. Film and sheet extrusion processes may include and are not limited to melt casting, blown film extrusion and calendaring. Co-extrusion and lamination processes may be employed to form composite multi-layer films or sheets. Single or multiple layers of coatings may further be applied to the single or multi-layer substrates to impart additional properties such as scratch resistance, ultra violet light resistance, aesthetic appeal, etc. Coatings may be applied through standard application techniques such as rolling, spraying, dipping, brushing, or flow-coating. Film and sheet of the invention may alternatively be prepared by casting a solution or suspension of the composition in a suitable solvent onto a substrate, belt or roll followed by removal of the solvent.

In one embodiment, a lighting assembly comprising the composition described herein is disclosed. The lighting assembly may be used with replaceable incandescent, halogen or fluorescent lamps. The lighting assembly comprising the composition exhibits little or no outgassing. Outgassing can cause fogging of the lenses and/or reflectors which can adversely affect the appearance, aesthetics, and photometric performance of the overall lamp assembly.

Accordingly, another embodiment of the invention relates to articles, sheets and films prepared from the compositions above. Exemplary articles include automotive radiator end caps, connectors, particularly automotive connectors for under the hood applications, articles in fluid engineering such as hydro-blocks and pipe fittings, marine applications such as connectors, engine covers, and other articles that may come in contact with salt water.

The following non-limiting examples further illustrate the various embodiments described herein.

### EXAMPLES

The following examples were prepared using the materials listed in Table I. The examples also contain 1.3 to 1.5 weight percent stabilizers, colorants and anti-oxidants. The amounts shown in Tables II are in weight percent. Weight percent, as used in the examples, was determined based on the total weight of the composition.

TABLE I

| Material Name | Material Description/Supplier |
|---|---|
| PPE | A polyphenylene ether with an |
| | intrinsic viscosity of 0.46 dl/g as |
| | measured in chloroform at 25° C. |
| SEBS | Polystyrene-poly(ethylene-butylene)- |
| | polystyrene impact modifier |
| | commercially available from |
| | KRATON Polymers as KRATON |
| | G1651. |
| PA9T | An aliphatic-aromatic polyamide |
| | having an amine end group content of |
| | 77 micromoles per gram of polyamide |
| | and a melt viscosity of 2000 poise at a |
| | shear rate of 1000 s⁻¹ and 330° C. Of |
| | the units derived from a dicarboxylic |
| | acid 100 mol % are derived from |
| | terephthalic acid. Of the units derived |
| | from diamine 100 mol % are derived |
| | from 1,9-nonanediamine, 2-methyl- |
| | 1,8-octanediamine or a combination |
| | thereof. |
| PA 6,6 | Nylon 6,6 with a relative viscosity of |
| | 46-50 dl/g commercially available |
| | from Solutia as VYDYNE 21Z. |
| Fumaric acid | Available from Ashland Chemical |
| Citric acid | Available from Cargill |
| Glass Fibers | Chopped glass fibers commercially |
| | available as Advantex 173X-11C from |
| | Owens Corning. |

The examples were molded into bars for moisture absorption testing as described above and also into Type I tensile bars as described above. The bars were handled as described above with regard to moisture absorption measurements and tensile modulus testing. On the days indicated below, samples were removed from the humidity chamber and tested for tensile modulus according to ASTM D 638-01. Moisture content is reported in weight percent (wt %). Tensile modulus is reported in megaPascals (Mpa). Tensile stress is reported in percent (%).

### Examples 1-5

Poly(arylene ether), aliphatic-aromatic polyamide, impact modifier, additives, stabilizers, and fumaric acid (as shown in Table II) were added at the feed throat of a 30 millimeter Werner and Pfleiderer twin screw extruder and melt mixed at a screw speed of 350 rotations per minute and a feed rate of 13.6 kilograms per hour and a temperature of 305° C. The glass fibers were added downstream. The material was pelletized, dried, injection molded and tested for tensile modulus and tensile stress prior to humidity aging and during humidity aging as described above. Formulations and results are shown in Table II.

TABLE II

| Component | 1* | 2 |
|---|---|---|
| PPE | 40 | 40 |
| PA9T | — | 42 |
| PA6,6 | 42 | — |
| SEBS | 6 | 6 |
| Fumaric Acid | | 0.5 |
| Citric acid | 0.7 | |
| Glass Fibers | 10 | 10 |
| Tensile modulus after molding (no humidity exposure) (MPa) | 3942.2 | 3725 |
| Tensile modulus after 1 day of humidity exposure (MPa) | 3461 | 3739.1 |
| Tensile modulus after 4 days of humidity exposure (MPa) | 2954.6 | 3874.3 |
| Tensile modulus after 7 days of humidity exposure (MPa) | 2676 | 3798 |
| Tensile modulus after 14 days of humidity exposure (MPa) | 2470.6 | 3893.4 |
| Tensile modulus retention after 1 day of humidity exposure (%) | 87.79 | 100.38 |
| Tensile modulus retention after 4 days of humidity exposure (%) | 74.95 | 104.01 |
| Tensile modulus retention after 7 days of humidity exposure (%) | 67.88 | 101.96 |
| Tensile modulus retention after 14 days of humidity exposure | 62.67 | 104.52 |
| (%) | | |
| Tensile stress after molding (no humidity exposure) (%) | 85.35 | 86.24 |
| Tensile stress after 1 day of humidity exposure (%) | 70.46 | 83.66 |
| Tensile stress after 4 days of humidity exposure (%) | 64.19 | 83.48 |
| Tensile stress after 7 days of humidity exposure (%) | 60.97 | 82.11 |
| Tensile stress after 14 days of humidity exposure (%) | 58.95 | 81.97 |
| Tensile stress retention after 1 day of humidity exposure (%) | 82.55 | 97.01 |
| Tensile stress retention after 4 days of humidity exposure (%) | 75.21 | 96.80 |
| Tensile stress retention after 7 days of humidity exposure (%) | 71.44 | 95.21 |
| Tensile stress retention after 14 days of humidity exposure (%) | 69.07 | 95.05 |
| Moisture content after 1 day of humidity exposure (wt %) | 0.606 | 0.23 |
| Moisture content after 4 days of humidity exposure (wt %) | 1.19 | 0.466 |
| Moisture content after 7 days of humidity exposure (wt %) | 1.61 | 0.602 |
| Moisture content after 14 days humidity exposure (wt %) | 1.95 | 0.725 |

*Comparative Example

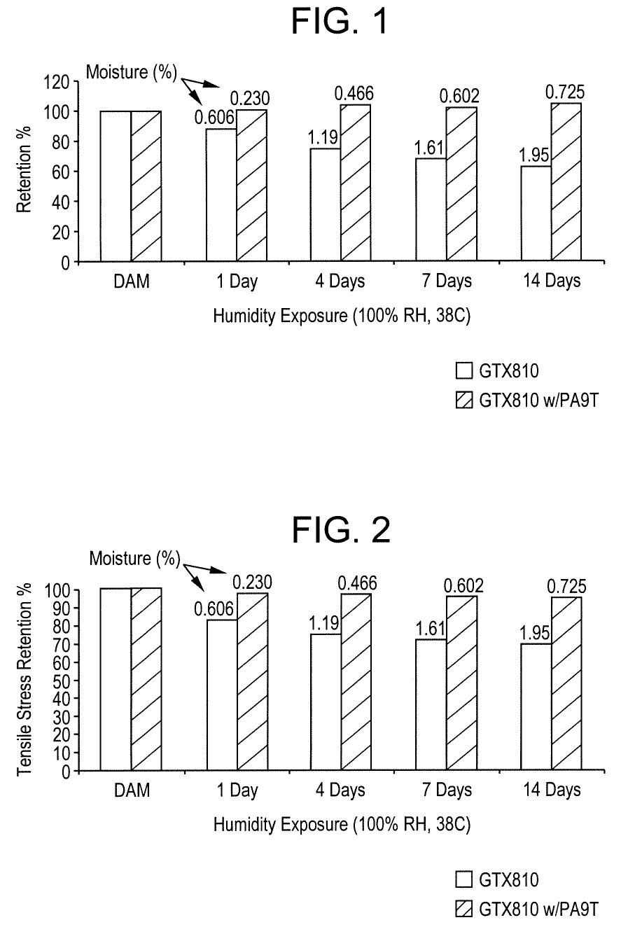

A comparison of Examples 1 and 2 shows that reinforced compositions containing a compatibilized blend of a poly(arylene ether)/aliphatic polyamide and reinforced compositions containing a compatibilized blend of a poly(arylene ether)/aliphatic-aromatic polyamide have unexpected markedly different retention of tensile modulus and tensile stress after humidity exposure. This is made more remarkable when a comparison is made between samples with similar moistures levels such as Example 1 after 1 day of humidity exposure (a moisture content of 0.6 wt %, a tensile modulus retention of 88% and a tensile stress retention of 82%) compared to Example 2 after 7 days of humidity exposure (a moisture content of 0.6 wt %, a tensile modulus retention of 102%, and a tensile stress retention of 95%). FIG. 1 and FIG. 2 are graphical representations of the same data.

While the invention has been described with reference to various embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

All cited patents are incorporated by reference herein.

1. A composition comprising;
5 to 20 weight percent fibrous filler, based on the total weight of the composition; and
a compatibilized blend of a poly(arylene ether) and an aliphatic-aromatic polyamide,
wherein the aliphatic-aromatic polyamide comprises:
units derived from dicarboxylic acid wherein 60 to 100 mol % of the units derived from dicarboxylic acid are derived from terephthalic acid and
units derived from diamine wherein 60 to 100 mol % of the units derived from diamine are derived from 1,9-nonanediamine, 2-methyl-1,8-octanediamine units, or a combination of 1,9-nonanediamine and 2-methyl-1,8-octanediamine,
wherein the aliphatic-aromatic polyamide, prior to forming the compatibilized blend, has an amine end group content greater than 45 micromoles per gram of the aliphatic-aromatic polyamide, and
wherein the composition has a tensile modulus, after being exposed to 100% humidity and 38° C. for 7 days, that is greater than or equal to 95% of the tensile modulus prior to being exposed to 100% humidity and 38° C. for 7 days.

2. The composition of claim 1 wherein the composition has a water absorption value less than or equal to 0.3 wt % after 24 hours at 100% humidity and 38° C.

3. The composition of claim 1, further comprising an impact modifier wherein the impact modifier comprises a block copolymer of an alkenyl aromatic compound and a conjugated diene, a hydrogenated block copolymer of an alkenyl aromatic compound and a conjugated diene, a functionalized elastomeric polyolefin, or a combination of two or more of the foregoing.

4. The composition of claim 3, wherein the poly(arylene ether) is present in an amount of 10 to 50 weight percent, the aliphatic-aromatic polyamide is present in an amount of 40 to 80 weight percent, based on the combined weight of poly(arylene ether), aliphatic-aromatic polyamide and impact modifier.

5. The composition of claim 3, wherein the impact modifier is present in an amount of 3 to 30 weight percent, based on the combined weight of poly(arylene ether), aliphatic-aromatic polyamide and impact modifier.

6. The composition of claim 1, wherein the compatibilized blend of a poly(arylene ether) and an aliphatic-aromatic polyamide further comprises an aliphatic polyamide.

7. The composition of claim 1, wherein the compatibilized blend of poly(arylene ether) and an aliphatic-aromatic polyamide is the reaction product of a poly(arylene ether), an aliphatic-aromatic polyamide, and a compatibilizing agent selected from monomeric polyfunctional compounds having both a carbon-carbon double bond and at least one carboxylic acid, anhydride, epoxy, imide, amide, ester group or functional equivalent thereof; polyfunctional compounds having both a group represented by the formula (OR) wherein R is hydrogen or an alkyl, aryl, acyl or carbonyl dioxy group and at least two groups each of which may be the same or different selected from carboxylic acid, acid halide, anhydride, acid halide anhydride, ester, orthoester, amide, imido, amino, and salts thereof; and combinations of two or more of the foregoing monomeric polyfunctional compounds.

8. The composition of claim 6, wherein the compatibilizing agent comprises citric acid, fumaric acid, maleic anhydride, or a combination of two or more of the foregoing.

9. The composition of claim 1, further comprising an anti-oxidant, flame retardant, drip retardant, dye, pigment, colorant, stabilizer, small particle mineral, electrically conductive filler, antistatic agent, plasticizer, lubricant, blowing agent, or a mixtures comprising two or more of the foregoing.

10. The composition of claim 1, wherein the composition further comprises an electrically conductive filler selected from carbon black, carbon fibers, carbon fibrils, carbon single wall nanotubes, carbon multi wall nanotubes and a combination combinations of two or more of the foregoing electrically conductive fillers.

11. An article comprising the composition of claim 1.

12. The article of claim 11 wherein the article is a lighting fixture.

13. A composition consisting essentially of:
5 to 20 weight percent glass fiber, based on the total weight of the composition; and
a compatibilized blend of a poly(arylene ether) and an aliphatic-aromatic polyamide
wherein the aliphatic-aromatic polyamide comprises:
units derived from dicarboxylic acid wherein 60 to 100 mol % of the units derived from dicarboxylic acid are derived from terephthalic acid and
units derived from diamine wherein 60 to 100 mol % of the units derived from diamine are derived from 1,9-nonanediamine, 2-methyl-1,8-octanediamine units, or a combination of 1,9-nonanediamine and 2-methyl-1,8-octanediamine,
wherein the aliphatic-aromatic polyamide, prior to forming the compatibilized blend, has an amine end group content greater than 45 micromoles per gram of aliphatic-aromatic polyamide.

14. An article comprising the composition of claim 13.

15. The article of claim 15 wherein the article is a lighting fixture.

16. A composition consisting of:
5 to 20 weight percent glass fiber, based on the total weight of the composition;
0 to 50 wt % additives, based on the total weight of the composition; and
a compatibilized blend of a poly(arylene ether) and an aliphatic-aromatic polyamide wherein the aliphatic-aromatic polyamide comprises:
units derived from dicarboxylic acid and 60 to 100 mol % of the units derived from dicarboxylic acid are derived from terephthalic acid; and
units derived from diamine and 60 to 100 mol % of the units derived from diamine are derived from 1,9-nonanediamine, 2-methyl-1,8-octanediamine units, or a combination of 1,9-nonanediamine and 2-methyl-1,8-octanediamine;
wherein the aliphatic-aromatic polyamide, prior to forming the compatibilized blend, has an amine end group content greater than 45 micromoles per gram of aliphatic-aromatic polyamide.
